(19) United States
(12) Patent Application Publication
(10) Pub. No.: US 2013/0054450 A1
(43) Pub. Date: Feb. 28, 2013

(54) Monetization of Atomized Content

(71) Applicant: Richard Lang, Santa Rosa, CA (US)

(72) Inventor: Richard Lang, Santa Rosa, CA (US)

(21) Appl. No.: 13/601,984

(22) Filed: Aug. 31, 2012

Related U.S. Application Data
(60) Provisional application No. 61/529,904, filed on Aug. 31, 2011.

(51) Int. Cl. G06Q 20/22

(52) U.S. Cl. 705/39

(57) ABSTRACT

A system for monetizing content is disclosed.

### BACKGROUND OF THE INVENTION

1. Field of the Invention

Embodiments of the present invention relate to the ability of content providers in a variety of mediums to monetize content or “grabbed” content used in the context of a content creation service, social bookmarking toolbar, or mobile device application. The mechanics of “grabbing” content in connection with a content creation service, social bookmarking toolbar, or mobile device application is generally described and implemented via a system described in Exhibit A. The present invention also allows a content provider to customize licensing terms and provisions for content.

2. Description of the Related Art

Historically, the ability of a consumer to purchase digital content (primarily from an online source) has been limited to the purchase of the content in its entirety. A consumer, for example, has typically been restricted to the purchase of an entire book or article, or full-length video, movie, or television show, usually accessed via a website on the Internet. A consumer, at best, can purchase a musical track from a full album but otherwise does not have the means to atomize content. That is, a consumer cannot pick and choose, separate, or divide a desired portion, section, or fragment of content from a larger piece of content, nor does the consumer have the option of only purchasing a portion of a complete package of content. Generally, when purchasing or otherwise acquiring the desired content, the consumer pays for the content in its entirety and often receives undesired content in addition to the desired content.

The ability to atomize content presents a variety of advantages for consumers and content providers. A consumer, for example, would save money and/or pay less to purchase portions of content rather than the whole. Also, since only desired portions of content would be purchased, the consumer would not have to receive and/or store undesired content. Consumers would also benefit from an incentive to content providers to create content that is more desired and favored by consumers. Since, with the use of the invention, consumers may atomize content, content providers may be incentivized to create content that is desirable from beginning to end and to maximize monetization of the content by permitting its atomization and related e-commerce. Content providers may also benefit by increased profits by the ability to base content prices on a variety of factors such as real-time consumer demand and variable licensing profiles with associated variable licensing terms.

### BRIEF DESCRIPTION OF THE FIGURES

FIG. 1 illustrates a system for monetizing content.

FIG. 2 illustrates a block diagram of an exemplary application server.

FIG. 3 is a flow chart illustrating a method for monetizing content.

### DETAILED DESCRIPTION

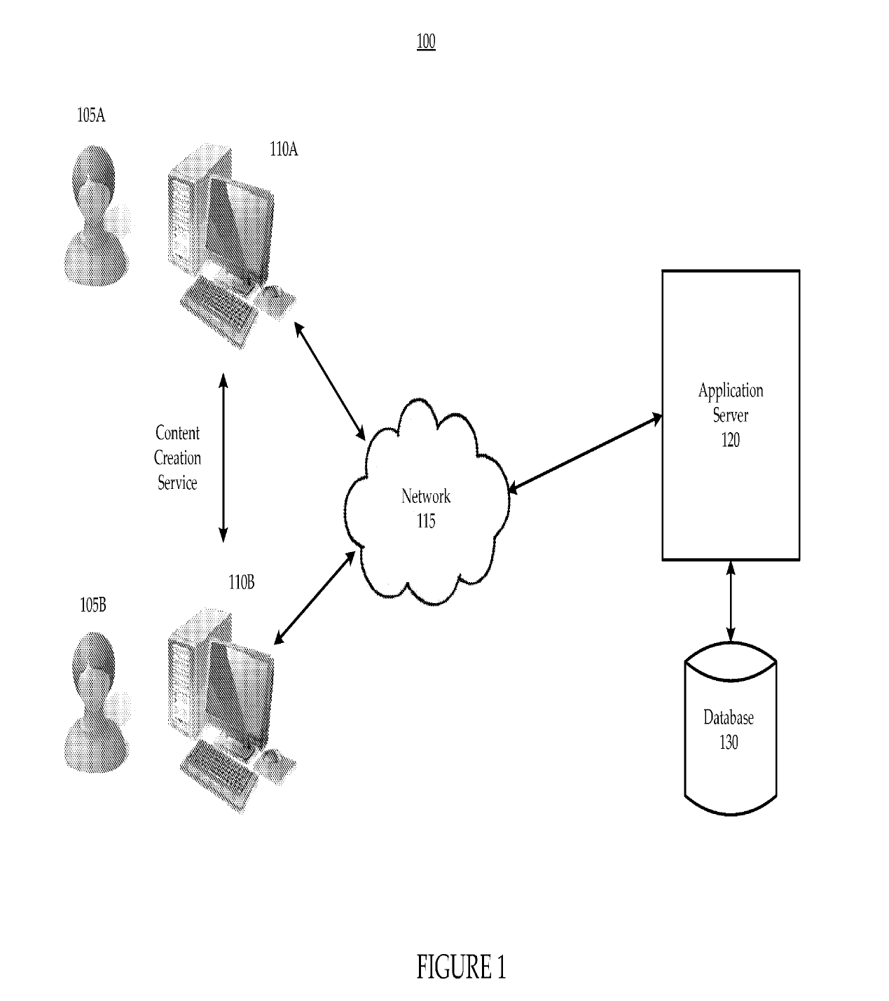

FIG. 1 illustrates a system for monetizing content used in the context of a content creation (or atomization) service, social networking toolbar, or mobile device application. The content monetization system 100 of FIG. 1 includes a user (105A, 105B), computing device (110A, 110B), network 115, application server 120, and database 130.

Content monetization system 100 may include a number of users and computing devices in connection with a content creation (or atomization) service, social networking toolbar, or mobile device application. In FIG. 1, a user (105A, 105B) accesses a content creation service, social bookmarking toolbar, or mobile device application using any computing device (110A, 110B) (e.g., workstation, server, lap top computer, cellular telephone, mobile device, etc.) capable of accessing information over a communication network 115 known in the art. Computing device (110A, 110B) may receive data or a request (e.g., from another computing device) and send the data or request over communications network 115 to application server 120 for processing. Communications network 115 is inclusive of any communications network such as the Internet, Wide Area Network (WAN), Local Area Network (LAN), intranet, extranet, private network, or other network.

Using computing device 110A, user 105A may subscribe or register (e.g., create an account) with a content creation (or atomization) service, social networking toolbar, or mobile device application provided by application server 120. Once user 105A has registered, user 105A may access the content creation (or atomization) service, social bookmarking tool, or mobile device application to perform a variety of tasks such as sharing content, accessing content, and creating discussion forums and/or new content. User 105A may be a content provider and/or purchaser of atomized content. User 105A may be associated with one or more user profiles. User 105A, for example, may have a “student” profile, “teacher” profile, “professional” profile, or “non-profit” profile, which may correlate to varying prices for the purchase of atomized content. User 105A may input various information and preferences (e.g., licensing information for provided content, preferences regarding access or searching content) for each user profile.

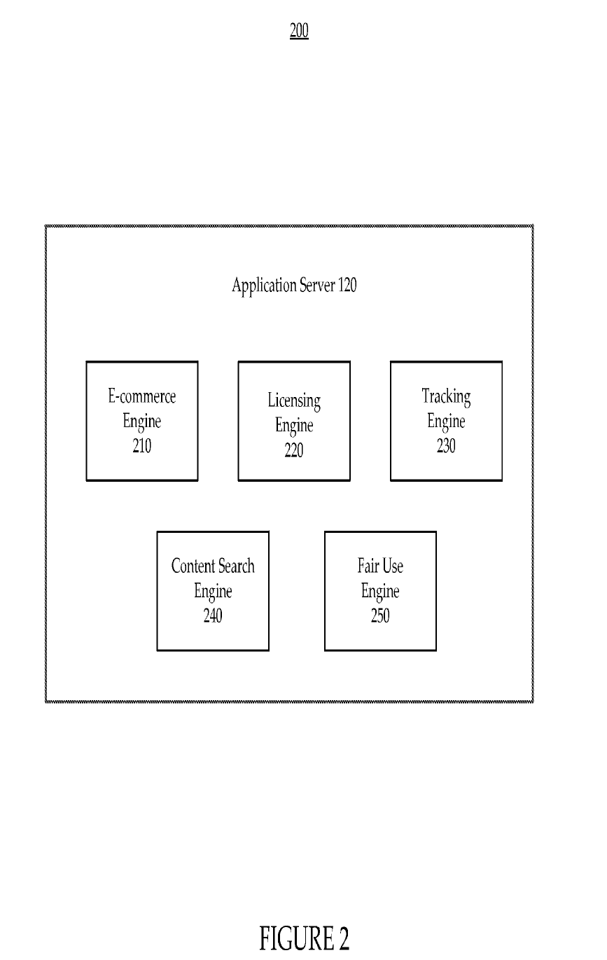

The application server 120 may host or service all of or various aspects of the content creation (or atomization) service, social networking toolbar, or mobile device application. The application server 120 may be implemented in a general computing device that otherwise communicates with database 130. Database 130 may store content, licensing information (as well as applicable terms under varying conditions), content tracking information, and other data for use with the content creation (or atomization) service, social bookmarking toolbar or mobile device application. Database 130 may be separate from or integrated with application server 120. Database 130 may also store data associated with each user (105A, 105B) (e.g., registration information, user profiles, and preferences, etc.). Database 130 may be distributed. The application server 120 of FIG. 1 may include various software modules or engines stored in memory and executable by a processor at the application server 120 or computing device (110A, 110B) to implement the present invention. Application server 120 is discussed in more detail in FIG. 2 below.

FIG. 2 illustrates a block diagram of an exemplary application server. Application server 120 may include various software modules or engines such as e-commerce engine 210, licensing engine 220, tracking engine 230, content search engine 240, and fair use engine 250. Although application server 120 is shown as having five software engines, the engines in FIG. 2 are exemplary and alternative embodiments may include additional or fewer elements and still be within the scope of the present invention.

A content provider may monetize content in a variety of ways. E-commerce engine 210 is executable by a processor to automatically calculate a price for highlighted or tagged content. Monetization may be based on the amount of content selected by user 105A. For example, user 105A (e.g., teacher) may be viewing content made available via the Internet or contained within discreet libraries of content within the content creation (or atomization) service, social bookmarking toolbar, or mobile device application. The content may include text, audio, video, or other media. If user 105A is interested in the media (e.g., a teacher believes the content is worthy of classroom discussion in the present time or future), user 105A may “grab” or select the content using any form known in the art such as highlighting, “drag and drop,” or “tagging.” User 105A may import or share the tagged content (e.g., text, image, photo, audio, etc. . . . ) in the context of the content creation (or atomization) service, social bookmarking toolbar, or mobile device application to (e.g., “create a new topic” or “start a new discussion”) with other users in a community of users (e.g., students). E-commerce engine 210 may calculate the particular price to charge user 105A for accessing the tagged content. User 105A may be allowed to grab, fully access, modify, and/or save the tagged content after consenting and/or authorizing payment for the same.

The e-commerce engine 210 may calculate a content price for the highlighted or tagged content based on the amount of content tagged or selected. If user 105A highlighted text, for example, user 105A may be charged a fee based on the number of characters highlighted (e.g., $0.05 per character/word). If user 105A selected audio or video, the user may highlight or select an entire audio or video file or portion thereof. Where only a portion of audio or video is selected, user 105A may create a start point and end point for use or import into the toolbar or mobile device application. The e-commerce engine 220 may calculate a fee based on the number of seconds or frames selected. E-commerce engine 220 may calculate content price in real-time and the calculated content price may be displayed to user 105A as content is being selected or highlighted.

E-commerce engine 210 may calculate content pricing based on other factors beyond quantity of content such as content quality, content demand, bulk buying, or content age. Price, for example, may depend on the quality, formatting, or resolution of the content, such as if the content is standard-definition or high-definition. Content demand may also affect price. Popular content that has been frequently purchased or accessed by users of the social networking toolbar or mobile device application may cost more than unpopular or infrequently accessed content.

Content price may also be influenced by bulk buying or the previous purchasing history of the user. A user may receive a discounted price for the tagged content, for example, if content is purchased in bulk or if the user has a history of frequent content purchases. Price may also be determined by the age of the content. Newer content may demand a higher price than older content. Content may be associated with a creation date or a date when the content was introduced into the toolbar or mobile device application. Content with a more recent creation date may cost more than content with an older creation or introduction date. Content may also be associated with a stale date so that content that has not been accessed within a period of time may be available at a lower price or free of charge to the user.

Content price may also depend on license provisions and restriction associated with the grabbed content. For example, content associated with more limitations (e.g., restrictions relating to the distribution, adaptation, or reproduction of the content, whether derivative works are permitted, and whether commercial and/or non-commercial use of the content is permitted) may cost less than content with fewer limitations or restrictions. Content price, payment rates, or fees associated with accessing and/or using content may also depend on the profile of the user (e.g., varying rates, prices or licensing terms if the user profile is that of “student,” “teacher,” “professional,” or “non-profit.”

A content provider or toolbar host may monetize content based on other fees collected from a user. For example, e-commerce engine 210 may calculate and charge a user a periodic (e.g., monthly, yearly, etc.) membership or subscription fee for the ability to use and import content into the content creation (or atomization) service, toolbar, or mobile device application. A content provider or toolbar host may also monetize content via content storage fees where a user is charged a fee for storing previously grabbed content in an online database or library such as in database 130.

E-commerce engine 210 may automatically bill calculated prices and fees to the PayPal®, credit card, or other charge account of the user. E-commerce engine 210 may automatically distribute collected fees to the content provider and/or host of the toolbar or mobile device application. Fees paid to the content provider and/or host may be based on a royalty, percentage, fee agreement, or other agreement previously negotiated by the content provider and/or host. Negotiated royalty and percentage information and agreements may be stored in database 130 which may contain a listing or library of all known agreements and their associated terms.

Embodiments of the present invention also provide a content provider (e.g., user 105A) with the ability to set forth and customize license terms (e.g., royalty), provisions, limitations, and restrictions related to the provided content. Licensing engine 220 is executable by a processor to generate a template requesting that a content provider specify multiple points of licensing information associated with the provided content. A pre-configured licensing template may be displayed to a content provider and include structured data or criteria fields. A content provider may select appropriate criteria fields from an existing list or be permitted to enter customized information. The content provider, for example, may set forth a royalty or price for tagged content (e.g., $0.05 per character/word, duration, or frame selected). Via the template, the content provider may also designate various license provisions including but not limited to: restrictions relating to the distribution, adaptation, or reproduction of the content, whether a user may create derivative works, and whether commercial and/or non-commercial use of the content is permitted. License information and restrictions associated with content may be displayed to a user in real time as content is highlighted, tagged, or quantified or qualified in any number of ways. That is, a user is able to easily visualize and/or access any licensing information, restrictions, and/or prohibitions associated with the desired content. License information and restrictions associated with content may also depend on the status or user profile of user 105A. For example, the licensing terms (e.g., content price, payment rates, or fees) associated with accessing and/or using content for user 105A who is a student (i.e., purchasing under a “student” profile) may be more favorable than for a non-student (i.e., a user purchasing under a “professional” profile).

Tracking engine 230 is executable by a processor to track when content is first provided and how such content is used over time. Tracking engine 230, for example, may track how content is grabbed, tagged, reproduced, copied, modified, uploaded, posted, and/or edited over time and which users are associated with the original and/or subsequently reproduced or modified content. Where a portion of particular content is used or accessed by user 105A, tracking engine 230 may track what portion of the original content is used and an appropriate chain of compensation. For example, if content provider A provides original content X and user B uses 75% of the original content X to produce content Y, the tracking engine 230 may track and store such information in database 130. E-commerce engine 210 may use such tracking information to calculate a price to charge user B for payment to content provider A, and if applicable, to the host of the content creation (or atomization) service, toolbar, or mobile device application. Tracking engine 230 may thus track how fees are collected, assigned, and paid.

Tracking engine 230 may also track and process attribution information associated with tagged content. Attribution information may include the author or creator of the tagged content and the original source or location of the content. Attribution information may further include licensing information, restrictions, and agreements associated with the tagged content. For example, when content is grabbed, tagged, reproduced, or copied, tracking engine 230 may associate and/or track the attribution information with the tagged content. If the content is reproduced, copied, uploaded, posted, edited, and/or modified in any way, application server 120 may display such attribution information to the user and any subsequent user viewing or accessing the content.

Content search engine 240 is executable by a processor to identify content for user access. User 105A may search for content accessible via the content creation (or atomization) service, social networking toolbar, or mobile device application. Content search engine 240 may search database 130 for relevant content and present the search results to user 105A. In one embodiment, content search engine 240 identifies content based on information supplied by user 105A such as subject matter, keyword(s), and tags. Content search engine 240 may also identify content based on licensing information associated with the content such as royalty, provisions, limitations, and restrictions. User 105A, for example, may wish to access content (e.g., text) related to World War II that cost no more than $0.05 per character and has no restrictions regarding creating derivative works.

In another embodiment, content search engine 240 provides search results that match a user's intended use for the content and compliance with licensing provisions associated with the content. For example, when searching for content, in addition to providing keywords or tags, user 105A may also specify the intended use of the content such as the re-post of the content or creation of a derivative work. In response, content search engine 240 may provide content whose licensing provisions and terms permit the intended use(s) of user 105A. For example, if user 105A wanted content related to the Battle of Midway that allowed for the creation of derivative works, content search engine 240 would provide search results matching such description to user 105A. Any search results relating to the Battle of Midway that do not allow for the creation of derivative works would not be presented to user 105A. Thus, where a user's intended use of content is not compatible with licensing provisions, limitations, or restrictions as set forth by the content provider, such content is not available for use or access by the user.

In another embodiment, content search engine 240 may provide search results matching a general profile (e.g., “student” profile, “teacher” profile, “professional” profile, or “non-profit” profile) associated with user 105A. As discussed in FIG. 1, user 105A may create an account to use the content creation (or atomization) services, toolbar, or mobile device application. When creating the account, user 105A may input registration information (e.g., name, address, e-mail address, phone number, etc.) as well as preferences for accessing, using, and searching content. User 105A may specify intended uses for content that is accessed via the content creation (or atomization) services, toolbar, or mobile device application. The user 105A, for example, may specify that access to content be granted only to particular content that permits user 105A to publish, post, distribute or prepare derivative works of the content. Content search engine 240 may provide content search results conforming to a particular profile of user 105A which the user is free to change or update at any time, even within a particular purchasing session if the intended destination or other use criteria of the purchased content changes.

Fair use engine 250 is executable by a processor to determine whether a particular use of content by user 105A is consistent with fair dealing rights under copyright law or other applicable laws. When user 105A accesses, publishes, posts, uploads, distributes, displays or provides content in the context of the content creation services, toolbar, or mobile device application, fair use engine 250 may determine whether the particular use of the content by user 105A is permitted by requesting that user 105A specify information associated with the provided content. A pre-configured fair use template may be displayed to user 105A and may include structured criteria or data fields. For example, user 105A may be asked to mark data fields or specify whether the intended use for the content is for commentary, criticism, news reporting, research, teaching, library archiving, or scholarship. User 105A may be also asked to indicate whether the intended use for the content is commercial or non-profit in nature. Based on the response by user 105A, fair use engine 250 may determine whether the use of such content is permitted and either grant or prohibit access to such content.

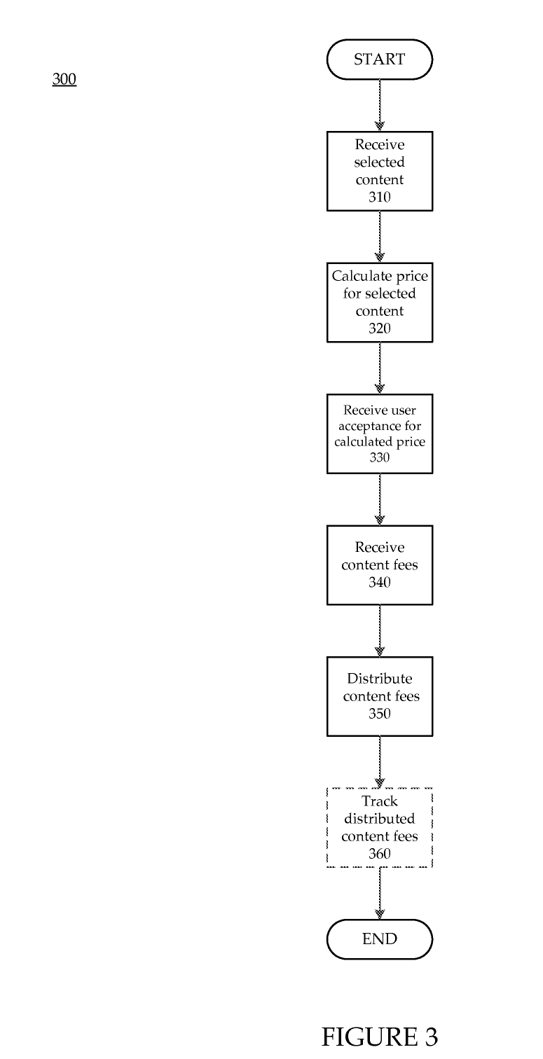

FIG. 3 is a flow chart illustrating a method for monetizing content. The steps identified in FIG. 3 (and the order thereof) are exemplary and may include various alternatives, equivalents, or derivations thereof including but not limited to the order of execution of the same. The method of FIG. 3 may be embodied in software stored in memory and executed by a processor.

At step 310, application server 120 may receive or detect content tagged, highlighted or otherwise selected by user 105A. The content may include text, audio, video, or other media. At step 320, application server 120 (e.g., e-commerce engine 210) may calculate a price associated with the selected content based on varying criteria. Price may depend on one or more factors such as amount, content quality, content demand, bulk buying, content age, or licensing restrictions associated with the content. Application server 120 may then display the calculated price to user 105A who may decide to proceed with purchasing the selected content. If user 105A accepts the calculated price (i.e., consents to pay for access to the desired content), application server 120 receives user acceptance at step 330.

At step 340, content fees are collected and received from user 105A. Collected content fees are paid to the content provider at step 350. In one embodiment, collected fees are divided and distributed to other parties besides the content provider such as (but not limited to) the host of the content creation (or atomization) services, social networking toolbar, or mobile device application based on a royalty, percentage, or fee agreement previously negotiated by the content provider and host. At optional step 360, application server 120 (i.e., tracking engine 240) tracks how fees are collected, assigned, and paid.

It should be noted that this invention is not intended to anticipate every possible variation on licensing terms and agreements that exist within the database component, but rather, to disclose a process by which any number of such agreements and terms can be correlated to specific portions of content that have been “atomized” in their selection by user 105A, and corresponding e-commerce that is invoked that properly represents the appropriate purchase or licensing rates which pre-exist in the database, along with any other processes which may be invoked to determine a purchase price if one does not exist at the time of the selection of content by user 105A.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

While the present invention has been described in connection with a series of preferred embodiments, these descriptions are not intended to limit the scope of the invention to the particular forms set forth herein. To the contrary, the present descriptions are intended to cover such alternatives, modifications, and equivalents as may be included within the spirit and scope of the invention as defined by the appended claim and otherwise appreciated by one of ordinary skill in the art.

1. A method for monetizing content, comprising:
receiving a selection of content tagged by a user, wherein the tagged content is a portion of content stored in memory and provided by a content provider;
executing instructions stored in memory, wherein execution of the instructions by a processor:
calculates a price for the tagged content, the price based in part on an amount of content selected,
processes a content fee from the user for the tagged content, and
distributes at least a portion of the received content fee to the content provider.

2. (canceled)

3. The method of claim 1, wherein the execution of instructions by the processor further tracks the distributed content fee.

4. The method of claim 1, wherein the execution of instructions by the processor further tracks usage of the tagged content by the user.

5. The method of claim 1, wherein execution of instructions by the processor further tracks attribution information associated with the tagged content.

6. The method of claim 1, wherein the execution of instructions by the processor further provides the tagged content to the user based on one or more licensing provisions associated with the content.

7. The method of claim 6, wherein the licensing provision is a distribution restriction associated with the tagged content.

8. The method of claim 6, wherein the licensing provision is a reproduction restriction associated with the tagged content.

9. The method of claim 1, wherein the price for the tagged content is further based on a profile associated with the user.

10. The method of claim 1, wherein the price for the tagged content is further based on content demand.

11. The method of claim 1, wherein the price for the tagged content is further based on a previous content purchase by the user.

12. The method of claim 1, wherein the price for the tagged content is further based on a creation date associated with the tagged content.

13. The method of claim 1, wherein the price for the tagged content is further based on a stale date associated with the tagged content.

14. The method of claim 1, wherein the price for the tagged content is further based on a license provision associated with the tagged content.

15. The method of claim 14, wherein the license provision includes a royalty fee.

16. A non-transitory computer-readable storage medium, having embodied thereon a program, the program being executable by a processor to perform a method for monetizing content, the method comprising:
receiving a selection of content tagged, wherein the tagged content is a portion of content provided by a content provider;
calculating a price for the tagged content, the price based in part on an amount of content selected;
processing a content fee for the tagged content; and
distributing at least a portion of the received content fee to the content provider.
